(19) United States
(12) Patent Application Publication
(10) Pub. No.: US 2024/0269801 A1
(43) Pub. Date: Aug. 15, 2024

(54) CONTROLLING SHOT PEENING DEVICE VIA SHOT MEDIA VELOCITY SENSING

(71) Applicant: Electronics Inc., Mishawaka, IN (US)

(72) Inventors: Jack M. Champaigne, Mishawaka, IN (US); Taylor Bowman, Mishiwaka, IN (US); Kenneth Derucki, Mishiwaka, IN (US); Erik Waelchli, Mishiwaka, IN (US)

(21) Appl. No.: 18/166,827

(22) Filed: Feb. 9, 2023

(51) Int. Cl. B24C 7/00; B24C 1/10; G01H 3/06; G01H 9/00; G01H 11/02; G01H 11/06

(52) U.S. Cl. CPC B24C 7/0053; B24C 1/10; G01H 3/06; G01H 9/00; G01H 11/02; G01H 11/06

(57) ABSTRACT

A method for controlling a velocity of media from a shot peening device includes defining a sensing area via a sensor; receiving media through the sensing area; and determining a frequency of the media through the sensing area. The method then includes determining, by a controller, a velocity of the media based on the frequency and a characteristic of the sensor; comparing, by the controller, the determined velocity to a desired velocity; and commanding, by the controller, the shot peening device to adjust the velocity of the media in response to the comparison.

### TECHNICAL FIELD

This disclosure generally relates to shot peening, and, specifically, controlling a shot peening device via a shot media velocity sensing.

### BACKGROUND

Shot peening is a surface enhancement process that imparts a compressive residual stress into the surface of a metal component by impacting a shot media, such as metallic, ceramic, glass, or other suitable peening particles at high velocity.

### BRIEF DESCRIPTION OF THE DRAWINGS

FIG. 1 is a side view of an example apparatus for determining a velocity of shot media and controlling the media based on the sensed velocity according the various examples disclosed herein.

FIG. 2 is a side view of an example apparatus for determining a velocity of shot media and controlling the shot media based on the sensed velocity according the various examples disclosed herein.

FIG. 3 is a side view of an example apparatus for determining a velocity of shot media and controlling the shot media based on the sensed velocity according the various examples disclosed herein.

FIG. 4 is a flow chart illustrating an example method of determining a velocity of shot media for use with the various apparatuses disclosed herein.

FIG. 5 is a flow chart illustrating an example method of controlling a velocity of shot media for use with the various apparatuses disclosed herein.

FIG. 6 is a block diagram view of an example system for determining a velocity of shot media and controlling the shot media based on the sensed velocity according the various examples disclosed herein.

FIG. 7 is a diagrammatic view of an example of a user computing environment in which the methods described herein may be employed.

### DETAILED DESCRIPTION

Shot peening is a surface enhancement process that imparts a compressive residual stress into the surface of a metal component by impacting metallic, ceramic, or glass peening particles at high velocity. The intensity is based, at least in part, upon the kinetic energy of the shot, which is a function of the mass and velocity of the shot, as well as the hardness of the shot. When defining a peening process, designers specify an intensity which would achieve the required fatigue life improvement.

In one example, intensity is tested using a test coupon, as described in U.S. Pat. No. 2,350,440, which is used to establish a desired intensity at the beginning of the process and to periodically review the intensity during treatment. However, it is possible that the intensity may change between inspection cycles, which the test coupons would not detect until the next review. Additional peening intensity systems have been developed, such as described in U.S. Pat. Nos. 5,113,680 and 6,640,596, but each remains reliant on periodic testing. One system is based on optical sensors taking time-delayed photographs and defining a flight distance through image analysis. These systems, however, are “look-aside” systems outside of the actual peening process environment and often occur in a well-controlled, lab-like environment that require fixed and elaborate test set-ups. As such, these systems are more academic in value and are not able to evaluate the peening process continuously.

Furthermore, these known systems only provide either the kinetic energy or an approximate velocity of the shot media, and fail to determine which of the two variables (e.g., velocity or mass) is not within specifications. For example, because the kinetic energy is a product of both size and velocity, degraded shot media at a high velocity may appear to an operator to be a proper kinetic energy reading because the higher velocity compensates for the degraded shot media. However, in order to provide a more comprehensive assessment of the peening process to an operator, it would be helpful for the operator to know both the kinetic energy and the velocity imparted by a stream of shot media.

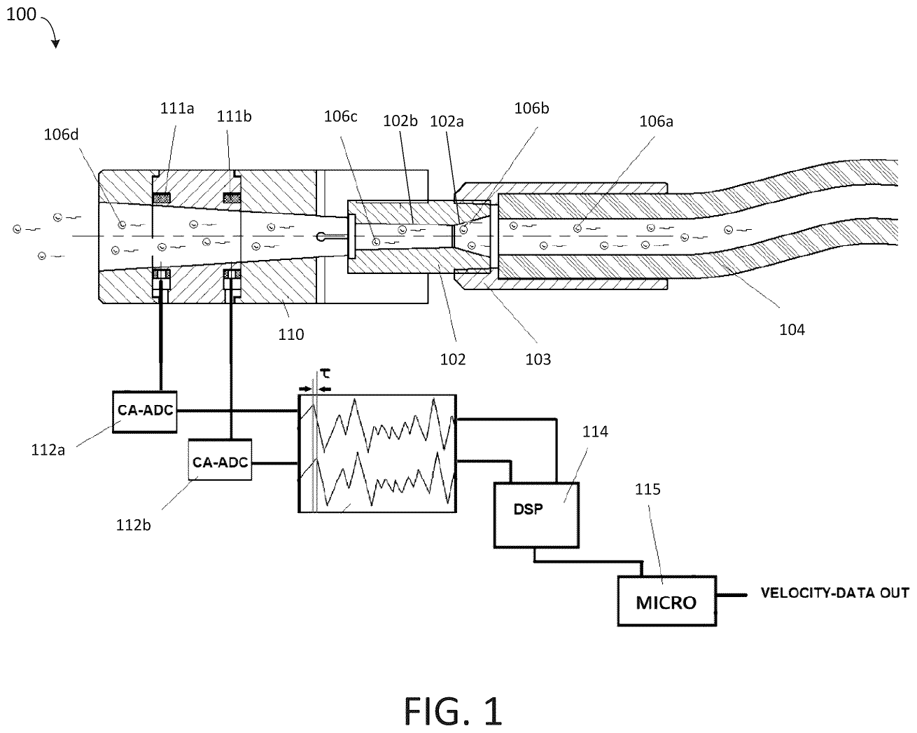

Referring now to the drawings, wherein like numerals refer to the same or similar features in the various views, FIG. 1 is a side view of an example apparatus 100 for sensing a velocity of shot media and controlling the shot media based on the sensed velocity. In some examples, the apparatus 100 may utilize magnetic field disruptions to sense velocity. As shown, the apparatus 100 includes a nozzle 102 and a media supply hose 104, which is connected to a first end of the nozzle 102 via a nozzle holder 103. In this example, unaccelerated shot media 106a are shown in the supply hose 104. When the shot media 106a enter a first chamber 102a of the nozzle 102, the shot media 106a become shot media 106b in a first acceleration phase, and when the shot media 106b enters a second chamber 102b of the nozzle 102, the shot media 106b become shot media 106c in a second acceleration phase. The shot media 106c then exits the nozzle 102 and become free-flying shot media 106d.

A sensor housing 110 is mounted to a second end of the nozzle 102. The example sensor housing 110 includes a first sensor 111a and a second sensor 111b. In this example, the first sensor 111a and the second sensor 111b are a conductive steel component (e.g., ring, pin, or coil) that has a static charge or generates a magnetic (or electrostatic) field. When the shot media 106d pass through the magnetic fields generated by the first sensor 111a and the second sensor 111b, the magnetic or electrostatic fields are disrupted or the static charge of the sensors 111a, 111b are affected due to the magnetic properties of the shot media 106d. When the first sensor 111a and the second sensor 111b detect or otherwise determine the disruption, they generate a suitable signal indicative of the disruption. In this example, the signals from the first sensor 111a and the second sensor 111b are amplified and/or converted (e.g., from analogue to digital) by a first amplifier 112a and a second amplifier 112b. From there, the amplified signals are processed by a processor 114, which analyzes the signals to identify a flow pattern of the shot media. For instance in this example, the processor 114 utilizes or applies a Fast Fourier Transform (FFT) to determine the frequency of the shot media 106d based on the time intervals between magnetic field disruptions. These time intervals are how much time passes between a single piece of shot media disrupting the magnetic field of the first sensor 111a and that same piece of shot media disrupting the magnetic field of the second sensor 111b, or the time intervals may be how much time passes between disruptions of a single magnetic field. It will be appreciated that other methods of processing the signals may be utilized as desired.

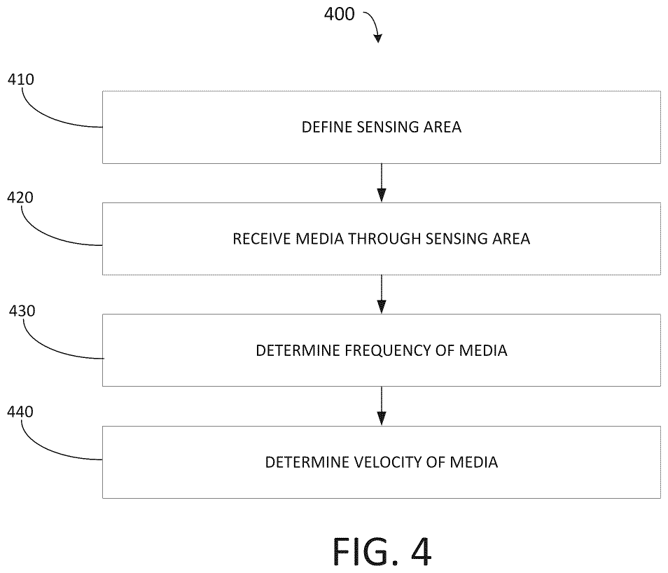

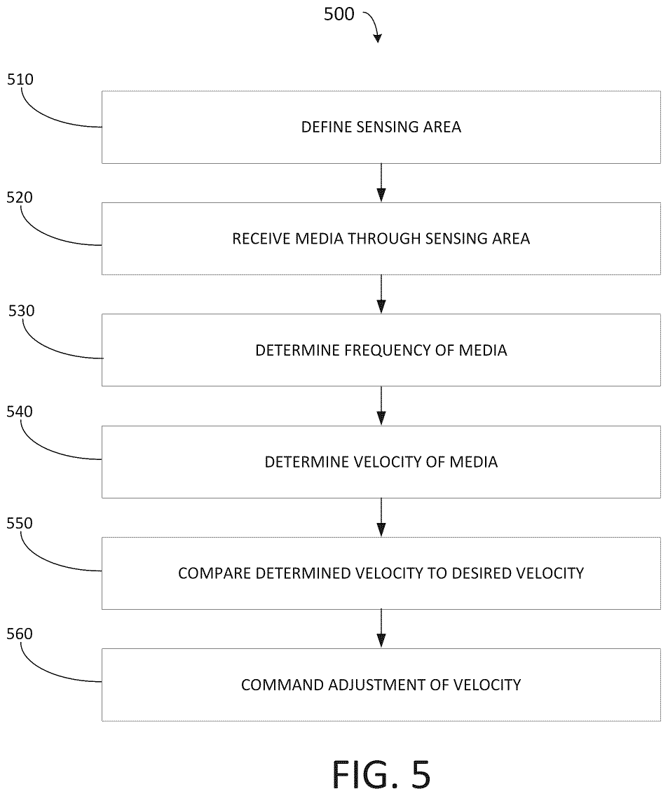

The output of the processor 114 is then received by the controller 115. Details of example methods of operation of the controller 115 are provided in method 400 of FIG. 4 and method 500 of FIG. 5. In those examples in which the output of the processor 114 is the result of the FFT, the controller 115 determines the velocity of the shot media 106d as a function of the determined frequency and a distance between the first sensor 111a and the second sensor 111b.

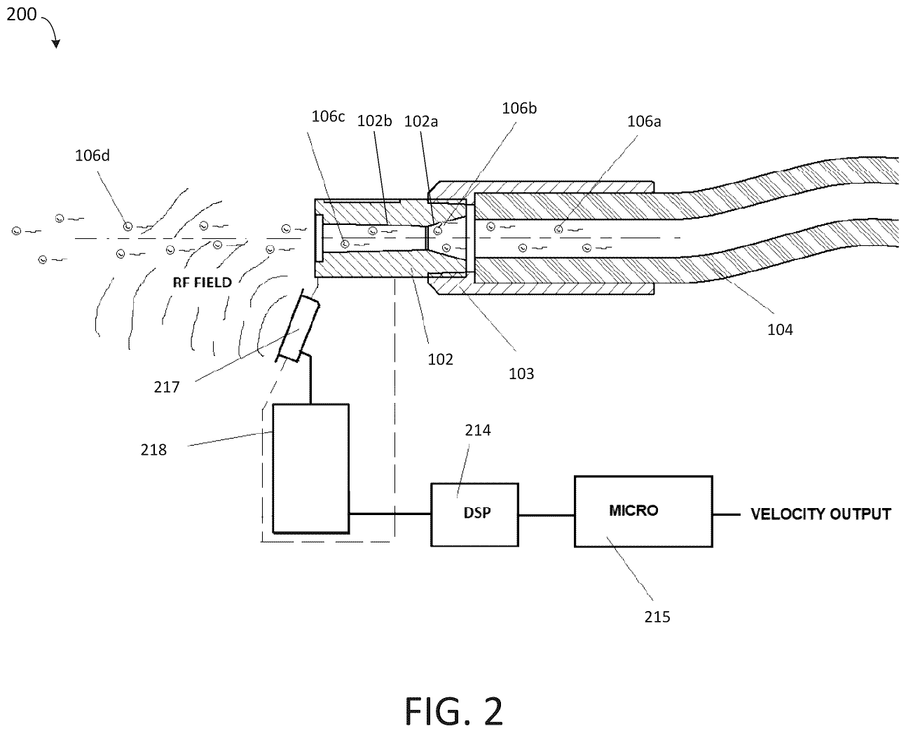

FIG. 2 is a side view of another example apparatus 200 for sensing a velocity of shot media and controlling the shot media based on the sensed velocity. In this example, the apparatus 200 utilizes the doppler effect from a Radio-Frequency (RF) signal to sense velocity. As with the apparatus 100, in this illustration, the apparatus 200 includes the nozzle 102 and the media supply hose 104, which is connected to a first end of the nozzle 102 via the nozzle holder 103. Unaccelerated shot media 106a are shown in the supply hose 104. When the shot media 106a enter a first chamber 102a of the nozzle 102, the shot media 106a become shot media 106b in a first acceleration phase, and when the shot media 106b enter a second chamber 102b of the nozzle 102, the shot media 106b become shot media 106c in a second acceleration phase. The shot media 106c then exit the nozzle 102 and become free-flying shot media 106d.

A radar sensor head 217 is positioned at the second end of the nozzle 102 and, in this example, oriented to broadcast an RF signal over at least a portion of the area at which the shot media 106d exit the nozzle 102 to generate an RF field. The RF signal is reflected back to the radar sensor head 217 by the shot media 106d passing through the RF field, and the radar sensor head 217 is used to determine the Doppler frequency based on the reflection. The radar sensor head 217 transmits a signal indicative of the doppler frequency to an amplifier 218 that amplifies, conditions, and/or converts (e.g., from analogue to digital) the signals.

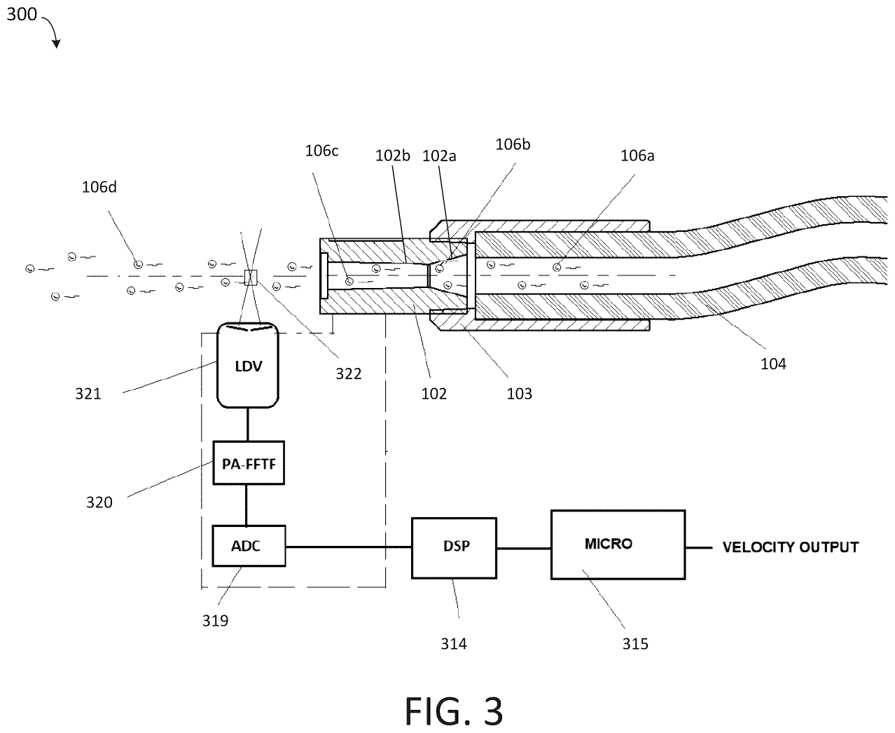

The signals are then received by a processor 214, which digitally analyzes and filters the signal. From there, the signals are received by a controller 215. Details of operation of the controller 215 are provided in FIG. 4 and FIG. 5. In the examples in which the output from the processor 214 is a doppler frequency signal, the controller 215 determines a velocity of the shot media 106d according to the following formula:

$$v = ( c / 2 f cos θ ) {f}_{d}$$

Where v is the velocity of the shot media (m/s), c is the speed of light (m/s), f is the frequency of the Doppler radar (Hz), θ is an angle of the radar sensor head (°), and f_{d} is the Doppler frequency (Hz). It will be appreciated that other methods of processing the signals may be utilized as desired. FIG. 3 is a side view of an example apparatus 300 for sensing a velocity of shot media and controlling the shot media based on the sensed velocity. In this example, the apparatus 300 utilizes Laser Doppler Velocimetry (LDV) to sense velocity. As shown, the apparatus 300 includes the nozzle 102 and the media supply hose 104, which is connected to a first end of the nozzle 102 via the nozzle holder 103. Unaccelerated shot media 106a are shown in the supply hose 104. When the shot media 106a enter the first chamber 102a of the nozzle 102, the shot media 106a become shot media 106b in a first acceleration phase, and when the shot media 106b enter the second chamber 102b of the nozzle 102, the shot media become shot media 106c in a second acceleration phase. The shot media 106c then exit the nozzle 102 and become free-flying shot media 106d.

As illustrated in this example, a sensor 321 is positioned at the second end of the nozzle 102. As shown, the example sensor 321 is a dual beam laser doppler velocimetry sensor configured to project or emit two lasers that intersect at a point 322 displaced from the sensor 321. When shot media 106d pass through the point 322, the lasers are disrupted, and a photo detector in the sensor 321 may record the disruption as a signal burst. The signal burst is amplified and filtered (e.g., by an FFT) by an amplifier 320 before being converted (e.g., from analogue to digital) by convertor 319. From there, the signal burst is digitally analyzed and filtered by a processor 314. From there, the signal burst(s) are received by a controller 315. Details of operation of the controller 215 are provided in method 400 of FIG. 4 and method 500 of FIG. 5. In those embodiments in which the output from the processor 314 is a signal burst based on LDV, the controller 315 may determine a velocity of the shot media 106d based on a change of the Doppler frequency of the signal burst(s). In an example, the controller 315 may determine a velocity of the shot media 106d according to the following formula:

$$v = \frac{{f}_{b} \times λ}{2 \times sin ( \frac{ϑ}{2} )}$$

where λ is a wavelength of the laser beams, and ϑ is an angle between the laser beams.

FIG. 4 is a flow chart illustrating an example method 400 of determining a velocity of shot media. The method 400, or one or more portions of the method 400, may be performed by apparatus 100 of FIG. 1, the apparatus 200 of FIG. 2, and the apparatus 300 of FIG. 3. The shot media here may be peening particles (e.g., metallic, ceramic, or glass shot) that are accelerated by and expelled from a shot peening device.

The method 400 includes, at block 410, defining a sensing area and, at block 420, receiving shot media through the sensing area. The sensing area may be a 3-dimensional space that is being actively monitored by sensor(s) (e.g., first sensor 111a, second sensor 111b, radar sensor head 217, or sensor 321) and through which shot media may pass. As such, the sensing area in this instance is defined substantially proximate to an exit point of the shot media from the shot peening device, such that at least a portion of the shot media being expelled from the shot peening device pass through the sensing area. In those embodiments in which the sensor(s) are magnetic sensors (e.g., apparatus 100), the sensing area(s) may be the magnetic fields generated by the sensors. In those embodiments in which the sensor(s) are radar-based (e.g., apparatus 200), the sensing area may be the RF field generated by the broadcast RF signal. In those embodiments in which the sensor(s) are laser-based (e.g., apparatus 300), the sensing area may be a path of the laser(s) or an intersection point of the lasers. In the instance that the apparatus employs other sensors, it will be appreciated that other methods of utilizing the sensors may be utilized as desired

The example method 400 includes, at block 430, determining a frequency of the shot media. In some examples of the present disclosure, frequency refers to a flow pattern of the shot media, such that the frequency of the shot media refers to a number of shot media that exit the shot peening device over a period of time, or a number of shot media that pass through the sensing area over a period of time. In other examples, frequency refers to a doppler frequency of the shot media, such that the frequency of the shot media refers to a change in movement of a wave broadcast towards and reflected back from the shot media.

The method 400 includes, at block 440, determining a velocity of the shot media. The determination may be based on the frequency of the shot media from block 430, as well as one or more characteristics of the sensors used to sense the shot media. In those examples in which the frequency is determined based on the shot media disrupting multiple magnetic fields, the relevant characteristic of the sensors may be a distance between the sensors generating the magnetic fields. In these embodiments, the velocity may be a product of the frequency and the distance, as the frequency is the rate at which the shot media pass between the sensors and the distance is the space that the shot media cover during those intervals, which would give a speed of the shot media. Because the positions of the sensors are known, a direction of travel of the shot media may also be known, which can be combined with the speed to determine a velocity.

In those examples in which the frequency from block 430 is a doppler frequency, the relevant characteristic of the sensor may be an angle of the sensor and a doppler frequency of the wave being broadcast from the sensor. The angle of the sensor may be defined relative to a flat plane, and the doppler frequency of the wave being broadcast from the sensor may be a known value that is dependent upon the type of wave being broadcast (e.g., a radio wave). Using those two characteristics, as well as a velocity of light, a velocity of the shot media may be determined according to the following formula:

$$v = ( c / 2 f cos θ ) {f}_{d}$$

Where v is the velocity of the shot media (m/s), c is the speed of light (m/s), f is the frequency of the Doppler radar (Hz), θ is an angle of the radar sensor head (°), and f_{d} is the Doppler frequency (Hz).

FIG. 5 is a flow chart illustrating an example method 500 of determining a velocity of shot media. The method 500, or one or more portions of the method 500, may be performed by apparatus 100 of FIG. 1, apparatus 200 of FIG. 2, and apparatus 300 of FIG. 3, in some embodiments. The shot media here may be peening particles (e.g., metallic, ceramic, or glass shot) that are accelerated by and expelled from a shot peening device.

The method 500 includes, at block 510, defining a sensing area, at block 520, receiving shot media through the sensing area, at block 530, determining a frequency of the shot media, and, at block 540, determining a velocity of the shot media. In this example, blocks 510-540 are analogous to blocks 410-440 of method 400.

The method 500 includes, at block 550, comparing the determined velocity to a desired velocity, and, at block 560, commanding an adjustment of the velocity. The desired velocity may be a pre-determined value based on the type of shot media, the type of surface being treated, or on a type of shot peening treatment. Commanding an adjustment of the velocity may involve sending a signal to the shot peening device to increase or decrease the forced acceleration of the shot media. For example, if the determined velocity is greater than the desired velocity, a command signal may be sent to the shot peening device to reduce a rate of acceleration by the shot peening device in proportion to the amount that the determined velocity is greater.

Apparatus 100 of FIG. 1, apparatus 200 of FIG. 2, and apparatus 300 of FIG. 3, as well as method 400 of FIG. 4, provide many benefits over the established prior art. First, because the sensing components are incorporated into the shot peening device itself, it is possible to perform testing of the shot media continuously throughout operation. Second, the sensing components enable testing of the shot media on-site, and do not require an elaborate set-up in a separate lab environment. Third, by analyzing the shot media in such a way, both the velocity and the kinetic energy can be determined. By combining this analysis with a media size sensor, the kinetic energy of the shot media may be determined according to the following formula:

$$KE = \frac{m \times {v}^{2}}{2}$$

where m is the mass (e.g., media size), and v is the determined velocity. Because previous systems do not simultaneously measure both variables, kinetic energy could only be determined by those previous systems at moments in time rather than continuously.

Method 500 of FIG. 5 provides many benefits over the established prior art. First, by utilizing a continuous testing procedure, changes in velocity or kinetic energy that would have otherwise evade notice of prior art testing are fully captured and analyzed. Second, because the analysis of the shot media is continuous and in real-time, changes to the shot media (e.g., increasing a velocity of the shot media in response to determining that the shot media are moving too slowly) are able to be made in real-time, which leads to a more effective and accurate shot peening process.

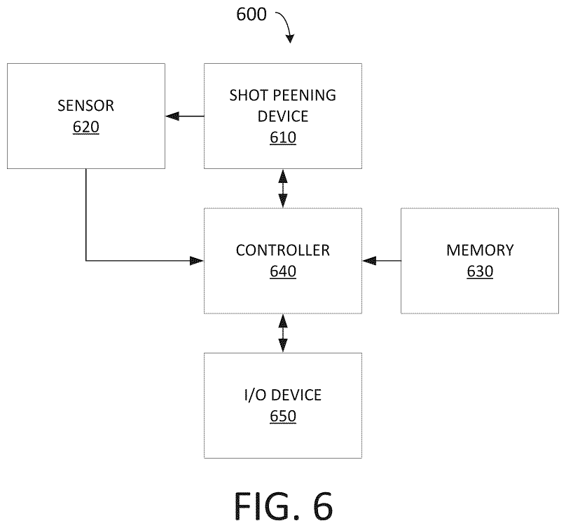

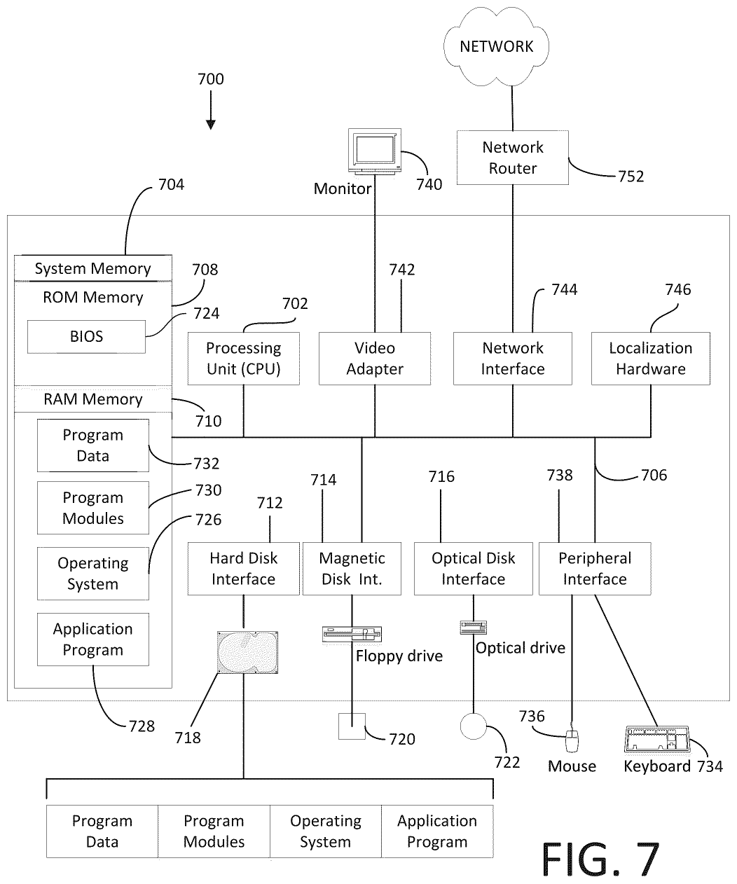

FIG. 6 is a block diagram view of an example system 600 for determining a velocity of shot media and controlling the shot media based on the sensed velocity. The various components of the example system 600 may be part of the apparatus 100 from FIG. 1, apparatus 200 from FIG. 2, and/or apparatus 300 from FIG. 3. The system 600 includes a memory 630 and a controller 640 operably coupled to the memory 630. The memory 630 may be one or more types of memory, and may store different data and/or computer readable media, which when executed by the processor may execute different methods for determining shot media velocity and adjusting the velocity disclosed herein, including controlling a shot peening device 610. The system 600 further includes a sensor 620 that is operably coupled to the controller 640 and configured to sense shot media being expelled from the shot peening device 610. The system also includes an input/output (“I/O”) device 650 configured to receive input (e.g., from a user) and communicate the input to the controller 640, and to receive output from the controller 640 and present the output (e.g., to the user). For example, the I/O device 650 may receive an indication of a desired shot media velocity. In one example, the methods described herein may also be executed by a computing device as shown in and described below with respect to FIG. 7, or may be executed using one or more components shown in and described below with respect to FIG. 7. For example, a velocity of the shot media from the shot peening device 610 may be determined by the controller 640 based on output from the sensor 620 (e.g., as discussed with respect to FIG. 4), and the controller 640 may command a change to the velocity by signaling the shot peening device (e.g., as discussed with respect to FIG. 5).

FIG. 7 is a diagrammatic view of an example of a user computing environment that includes a computing system environment 700, such as a desktop computer, laptop, smartphone, tablet, or any other such device having the ability to execute instructions, such as those stored within a non-transient, computer-readable medium. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 700 typically includes at least one processing unit 702 and at least one memory 704, which may be linked via a bus 706. Depending on the exact configuration and type of computing system environment, memory 704 may be volatile (such as RAM 710), non-volatile (such as ROM 708, flash memory, etc.) or some combination of the two. Computing system environment 700 may have additional features and/or functionality. For example, computing system environment 700 may also include additional storage (removable and/or non-removable) including, but not limited to, magnetic or optical disks, tape drives and/or flash drives. Such additional memory devices may be made accessible to the computing system environment 700 by means of, for example, a hard disk drive interface 712, a magnetic disk drive interface 714, and/or an optical disk drive interface 716. As will be understood, these devices, which would be linked to the system bus 706, respectively, allow for reading from and writing to a hard disk 718, reading from or writing to a removable magnetic disk 720, and/or for reading from or writing to a removable optical disk 722, such as a CD/DVD ROM or other optical media. The drive interfaces and their associated computer-readable media allow for the nonvolatile storage of computer readable instructions, data structures, program modules and other data for the computing system environment 700. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 700.

A number of program modules may be stored in one or more of the memory/media devices. For example, a basic input/output system (BIOS) 724, containing the basic routines that help to transfer information between elements within the computing system environment 700, such as during start-up, may be stored in ROM 708. Similarly, RAM 710, hard disk 718, and/or peripheral memory devices may be used to store computer executable instructions comprising an operating system 726, one or more applications programs 728 (which may include the functionality of the product grouping system 120 of FIG. 1 or one or more of its functional modules 706, 708, for example), other program modules 730, and/or program data 732. Still further, computer-executable instructions may be downloaded to the computing environment 700 as needed, for example, via a network connection.

An end-user may enter commands and information into the computing system environment 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus 706. Input devices may be directly or indirectly connected to processor 702 via interfaces such as, for example, a parallel port, game port, firewire, or a universal serial bus (USB). To view information from the computing system environment 700, a monitor 740 or other type of display device may also be connected to bus 706 via an interface, such as via video adapter 742. In addition to the monitor 740, the computing system environment 700 may also include other peripheral output devices, not shown, such as speakers and printers.

The computing system environment 700 may also utilize logical connections to one or more computing system environments. Communications between the computing system environment 700 and the remote computing system environment may be exchanged via a further processing device, such a network router 752, that is responsible for network routing. Communications with the network router 752 may be performed via a network interface component 744. Thus, within such a networked environment, e.g., the Internet, World Wide Web, LAN, or other like type of wired or wireless network, it will be appreciated that program modules depicted relative to the computing system environment 700, or portions thereof, may be stored in the memory storage device(s) of the computing system environment 700.

The computing system environment 700 may also include localization hardware 746 for determining a location of the computing system environment 700. In embodiments, the localization hardware 746 may include, for example only, a GPS antenna, an RFID chip or reader, a WiFi antenna, or other computing hardware that may be used to capture or transmit signals that may be used to determine the location of the computing system environment 700.

The computing environment 700, or portions thereof, may comprise one or more components of the apparatus 100 of FIG. 1, the apparatus 200 of FIG. 2, the apparatus 300 of FIG. 3, or the system 600 of FIG. 6 in one example.

While this disclosure has described certain examples, it will be understood that the claims are not intended to be limited to these examples except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed:

1. A method for determining a velocity of a shot media, the method comprising:
activating a sensor having a defined sensing area;
receiving the shot media through the defined sensing area;
determining a frequency of the shot media received through the defined sensing area; and
determining the velocity of the shot media based on the determined frequency and a predefined characteristic of the sensor.

2. The method of claim 1, wherein:
activating the sensor comprises generating a first magnetic field via a first magnetic sensor and a second magnetic field via a second magnetic sensor; and
determining the frequency of the shot media comprises determining a number of disruptions to the first magnetic field and the second magnetic field by the shot media.

3. The method of claim 2, wherein the predefined characteristic of the sensor is a distance between the first magnetic sensor and the second magnetic sensor, and wherein the velocity of the shot media is determined as a product of the frequency and the distance.

4. The method of claim 1, wherein the sensor comprises a first conductive steel component and a second conductive steel component, and wherein determining the frequency of the shot media comprises determining a number of changes to a static charge of the first conductive steel component and to the second conductive steel component.

5. The method of claim 4, wherein the characteristic of the sensor is a distance between the first conductive steel component and the second conductive steel component, and wherein the velocity of the shot media is determined as a product of the frequency and the distance.

6. The method of claim 1, wherein the sensor comprises a radar sensor, and wherein:
activating the sensor comprises generating a radio-frequency (RF) signal; and
determining the frequency of the shot media comprises receiving a reflection of the RF signal from the shot media.

7. The method of claim 6, wherein the characteristic of the sensor is an angle of the radar sensor, and wherein the velocity of the shot media is a function of the frequency, the angle, and a frequency of the radar sensor.

8. The method of claim 1, wherein:
the sensor comprises a laser sensor that emits one or more laser beams;
the defined sensing area comprises a point of intersection for the one or more laser beams; and
determining the frequency of the shot media comprises generating a signal burst when one of the shot media passes through the defined sensing area.

9. The method of claim 1, wherein determining the frequency of the shot media comprises applying a Fast Fourier Transform to an output from the sensor.

10. The method of claim 1, wherein the shot media are peening particles that are accelerated by and expelled from a shot peening device.

11. An apparatus for controlling a velocity of a shot media, the apparatus comprising:
a shot peening device configured to accelerate and expel the shot media;
a sensor having a defined sensing area; and
a computing system configured to:
determine a frequency of the shot media through the defined sensing area;
determine the velocity of the shot media based on the determined frequency and a predefined characteristic of the sensor;
compare the determined velocity of the shot media to a desired velocity of the shot media to determine a difference; and
control the shot peening device to adjust the velocity of the shot media in response to the comparison and the determined difference.

12. The apparatus of claim 11, wherein:
the defined sensing area comprises a magnetic field, and
the sensor is configured to send a signal to the computing system based on the shot media disrupting the magnetic field.

13. The apparatus of claim 12, wherein:
the sensor comprises:
a first sensor generating a first magnetic field, and
a second sensor generating a second magnetic field, and
the signal is indicative of a time interval between the shot media disrupting the first magnetic field and the shot media disrupting the second magnetic field.

14. The apparatus of claim 11, wherein:
the sensor comprises a radar head,
the sensing area comprises a radio-frequency (RF) field, and
determining the frequency of the shot media comprises:
receive, from the sensor, data regarding a Doppler frequency of the shot media based on the shot media reflecting the RF field, and
determining the frequency of shot media based on the received Doppler frequency.

15. The apparatus of claim 11, wherein the sensor comprises a laser, and wherein the sensor is configured to detect a disruption of the laser by the shot media and to transmit a signal indicative of the disruption to the computing system.

16. The apparatus of claim 15, wherein the laser comprises a first laser and a second laser, and wherein the sensing area comprises an intersection between the first laser and the second laser.

17. The apparatus of claim 15, wherein:
the shot peening device comprises:
a nozzle having a first end and a second end, and
a media hose coupled to the first end, the media hose configured to supply shot media to the nozzle,
the shot media is expelled from the second end of the nozzle, and
the sensing area is defined proximate to the second end of the nozzle.

18. A method for controlling a velocity of shot media from a shot peening device, the method comprising:
activating a sensor having a defined sensing area;
receiving the shot media through the defined sensing area;
determining a frequency of the shot media through the defined sensing area;
determining, by a controller, the velocity of the shot media based on the determined frequency and a predefined characteristic of the sensor;
comparing, by the controller, the determined velocity of the shot media to a desired velocity of the shot media to determine a difference; and
controlling, by the controller, the shot peening device to adjust the velocity of the shot media in response to the comparison and the determined difference.

19. The method of claim 18, further comprising determining, based on the comparison, that the determined velocity of the shot media is less than the desired velocity of the shot media,
wherein the controlling comprises increasing the velocity of the shot media.

20. The method of claim 18, further comprising determining, based on the comparison, that the determined velocity of the shot media is greater than the desired velocity of the shot media,
wherein the controlling comprises decreasing the velocity of the shot media.
